(19) United States
(12) Patent Application Publication
(10) Pub. No.: US 2010/0212260 A1
(43) Pub. Date: Aug. 26, 2010

(54) METHOD FOR CAPPING OR CLOSING CONTAINERS AND CAPPING OR CLOSING MACHINE

(76) Inventor: Ludwig Clüsserath, Bad Kreuznach (DE)

Correspondence Address: NILS H. LJUNGMAN & ASSOCIATES, P. O. BOX 130, GREENSBURG, PA, 15601-0130, US

(21) Appl. No.: 12/520,705

(22) PCT Filed: Nov. 8, 2007
(86) PCT No.: PCT/EP2007/009693

§ 371 Date: Jun. 22, 2009

(30) Foreign Application Priority Data
Dec. 23, 2006 (DE) 10 2006 061 498.4
Dec. 23, 2006 (DE) 20 2006 019 465.7

(51) Int. Cl. B67B 3/00; B65B 31/04; B65B 7/28

(52) U.S. Cl. 53/403; 53/432; 53/485; 53/86; 53/510; 53/287

(57) ABSTRACT

This invention relates to a method and to a capping or closing machine for the capping or closing of bottles or similar containers filled with an oxygen-sensitive product.

This invention relates to a method for the capping or closing of bottles or similar containers as described in the introduction to claim 1 and to a capping or closing machine as described in the introduction to claim 16.

A problem with many products, and with many beverages in particular, is that the shelf life and/or the quality, and in particular the taste, of products packaged in bottles or similar containers can be seriously and adversely affected by the inclusion of air or oxygen. The intrusion or inclusion of oxygen thereby occurs in particular during or after and product is filled into the bottle and/or during the capping or closing, e.g. via the open mouth of the container.

To remedy this problem, it is conventional with carbonated products such as beer, for example, to effect a controlled foaming of the product that is introduced into the respective container (e.g. bottle or can), and specifically by the injection of a foaming medium such as, for example, sterile water or a small amount of the product being bottled, to thereby use the foam that is formed above the surface of the product or liquid in the respective container to displace any air or oxygen that is present before the respective container is then closed or capped. One of several disadvantages with this method is that the foaming can result in significant product losses, and it is also necessary to control the foaming process so that an overfoaming or overflow of the product and thus a contamination of the external surface of the container can be prevented.

The object of the invention is a method and a capping or closing machine which prevents, respectively, an inclusion of oxygen in filled and closed containers that could adversely affect the shelf life and/or quality, in particular of oxygen-sensitive products, as well as the foaming of the respective product or liquid.

To accomplish this object, the invention teaches a method described in claim 1. A capping or closing machine (capper) is the object of claim 16.

The invention achieves at least a significant reduction of the oxygen inclusion in containers filled with a liquid and capped or closed so that a long shelf life is achieved with no reduction in quality, even with oxygen-sensitive products. Overfoaming losses of the type that were unavoidable during the displacement of air or oxygen by foaming are also prevented.

The use of the invention also makes it possible to omit the extremely cost-intensive and problem-plagued high pressure injection systems of the prior art that are used to foam the liquid being bottled.

In the invention, the inert gas atmosphere is contained in an inert gas chamber or a sub-chamber of an inert gas chamber, which (inert gas chamber or sub-chamber) is formed by or on the capping or closing machine, for example by a housing of the capping or closing machine. This realization guarantees that the space to be supplied with the inert gas and containing the inert gas atmosphere has the smallest possible volume.

In one embodiment of the invention, the containers are each completely enclosed in the inert gas chamber or sub-chamber, i.e. over their full container height, during the capping or closing, whereby the height of the inert gas chamber or sub-chamber then equals essentially only the height of the containers.

In an additional preferred embodiment of the invention, the containers are each contained in the inert gas chamber or sub-chamber during the capping or closing only with the mouth area that has their container mouth, i.e. over a portion of their height that contains the container mouth, so that a particularly small volume is achieved for the space to be supplied with the inert gas.

Developments of the invention are the object of the dependent claims. The invention is explained below in greater detail on the basis of the figures which show one exemplary embodiment, in which:

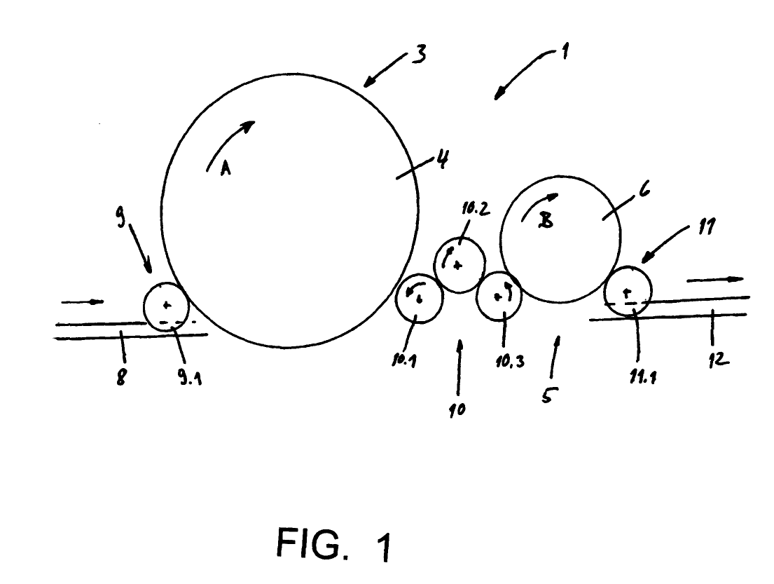

FIG. 1 is a schematic illustration of a plant for the filling of bottles or similar containers with a liquid and for the capping or closing of the containers in an inert gas atmosphere;

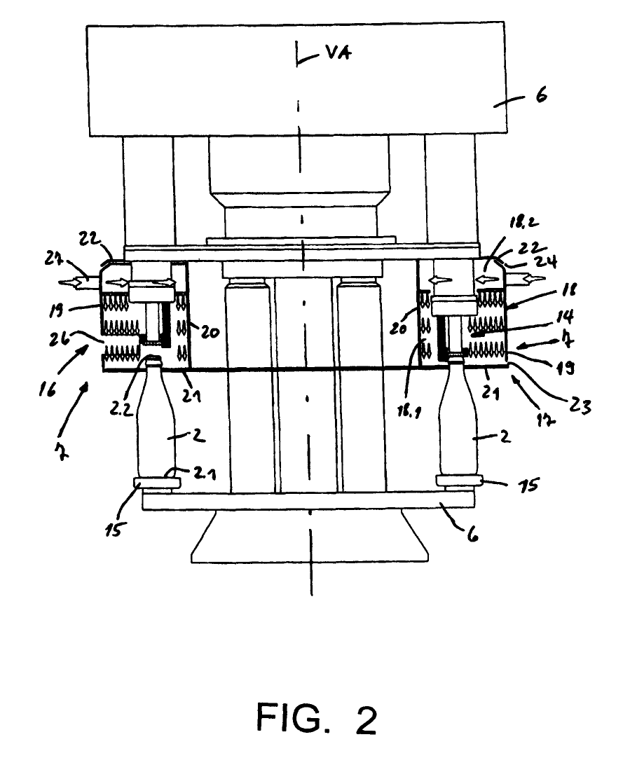

FIG. 2 is a simplified illustration of a capping or closing machine of the plant illustrated in FIG. 1;

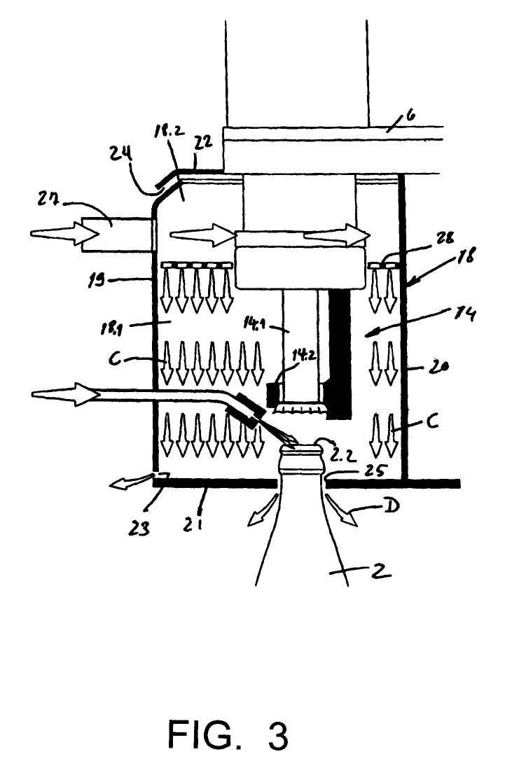

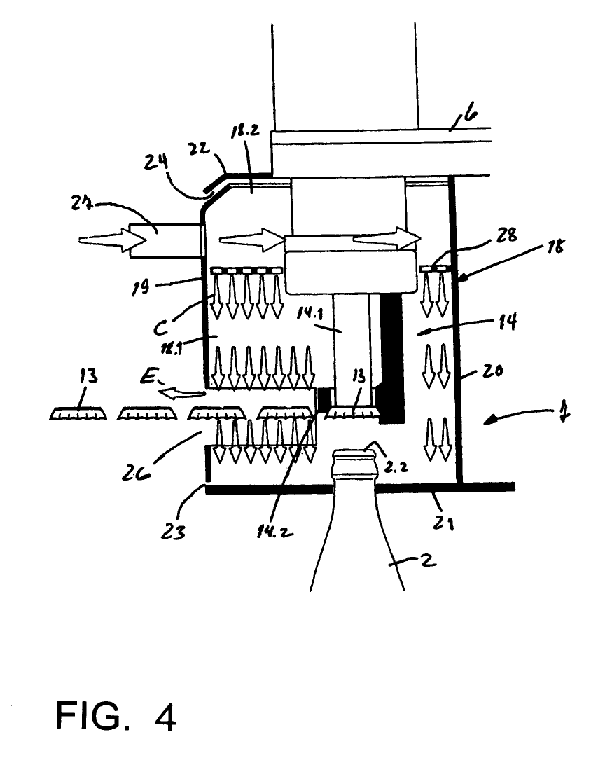

FIGS. 3 and 4 each show, in the form of enlarged details, various positions of the capping or closing machine illustrated in FIG. 2.

The plant which is designated 1 in general in the figures is used for the filling of containers which are realized in the form of bottles 2 in the embodiment illustrated in FIG. 2 with a liquid product, e.g. with a beverage, and for the capping of the bottles 2 after the filling.

For this purpose, the plant 1 includes a filling machine 3 which has, for example, the conventional configuration that will be familiar to a technician skilled in the art with a rotor 4 (arrow A) which is driven in rotation around a vertical machine axis, and with a plurality of filling positions realized on the perimeter of the rotor 4, as well as a capping or closing machine 5 which also employs a rotary construction, i.e. with a rotor 6 which is driven in rotation (arrow B) around a vertical machine axis VA, with a plurality of capping positions 7 (e.g. FIG. 2) formed on the perimeter of the latter rotor 6.

The bottles 2 are delivered to the filling machine 3 in an upright position, i.e. with their bottle axis oriented in a vertical direction, by means of a conveyor 8 to the container or bottle inlet 9 formed by a transport or inlet star wheel 9.1. The filled and capped or closed bottles 2 travel via a transport line 10 which is formed by a plurality of transport star wheels 10.1-10.3 to one of the capping or closing positions 7 of the capping machine 5 and after the capping or closing are transported further by means of a transport or outlet star wheel 11.1 that forms the container outlet 11 to the conveyor 12 to be transported away. The capping or closing positions are distributed around the perimeter of the rotor 6 in equal angular intervals around the vertical machine axis VA of the capping machine 5.

In the unit 1, in which the filling machine 3 and the capping or closing machine 5 can also be combined into a block, the bottles 2 are capped or closed with caps or closures 13 which are illustrated in the form of crown corks, although they can also be realized in other forms. For this purpose, each capping or closing position 7 consists of a capping or closing tool 14 and a container or bottle carrier 15 which is provided below the associated capping or closing tool 14 and in the illustrated embodiment is realized in the form of a bottle plate on which the individual bottle 2 stands upright during the capping with its base 2.1.

The capping or closing positions 7 and their capping or closing tools 14 are realized in a manner that will be familiar to a technician skilled in the art so that as the rotor 6 rotates around the axis VA, they each receive a cap 13 in a cap delivery position 16 (FIG. 2). This cap 13 is then placed on the container or bottle mouth 2.2 of the respective bottle in an angular portion of the rotational movement of the rotor 6 that is adjacent to the position 16, and is fixed in position on this mouth by pressing with a stamp 14.1 and by deformation with a capping cone 14.3, as illustrated by 17 on the right in FIG. 2.

The special characteristic of the capping or closing machine 5 is that the capping or closing of the bottles 2 with the caps 13 takes place in an inert gas atmosphere, i.e. the capping tools 14, i.e. their functional elements that interact with the caps 13 and bottles 2, namely in the illustrated embodiment their stamps 14′ and capping cones 14″, are located in an inert gas chamber 18 through which there is a constant flow of inert gas, and the atmosphere of which has an at least sharply reduced percentage of oxygen. During the capping or closing process, the bottles 2 with their mouth area that has the bottle mouth 2.2 extend into this inert gas chamber 18 or in a sub-chamber 18.1 of this inert gas chamber 18. In the illustrated embodiment, the inert gas chamber 18 is realized in the form of an annular chamber that concentrically encircles the axis VA, and specifically, for example, is bounded by a plurality of wall elements, namely by an outer wall element 19 in the shape of a circular cylinder which concentrically encircles the axis VA, by an inner wall element 20 which is also in the shape of a circular cylinder and concentrically encircles the axis VA, by a bottom circular cylindrical wall element 20 which is oriented in a plane perpendicular to the axis VA and which concentrically encircles this axis and by a top circular ring-shaped wall element 22 which encircles the axis VA.

With the exception of the wall element 19, the wall elements 20-22 are provided on the rotor 6, and specifically so that the wall element 21 extends externally horizontally to the bottom edge of the wall element 19 and closes the inert gas chamber 18 at that point except for a gap 24 which remains between the wall elements 19 and 21. The diameter of the wall elements 19 and 20 is selected so that the wall element 19 is farther from the axis VA than the capping tools 5, and is at a sufficient radial distance from the latter. The diameter of the wall element 30 that concentrically encircles the wall element 19 is selected so that the wall element 20 lies closer to the axis VA than the capping tools 5 and is at a sufficient radial distance from the latter.

In the bottom wall element 21, at each capping or closing position 7, or closing process an opening 25 is provided, through which the individual bottle 2 extends during the capping or closing from below with its mouth area that has the bottle mouth 22, and into the bottom sub-chamber 18.1 of the inert gas chamber 18. To make this possible, the container carriers 15 can be raised and lowered in a controlled manner in an axial direction parallel to the axis VA, e.g. by lifting devices which are not shown. After the transfer or each bottle 2 to a capping or closing position 7, the initially lowered container carrier 15 is raised for the capping or closing process and the bottles 2 in question is thereby moved with its mouth area through the opening 25 into the sub-chamber 18.1. After the capping or closing, the bottle 2 in question is lowered again with the respective container carrier 15, so that the bottle 2 is completely outside the inert gas chamber 18.

Also conceivable and within the scope of the invention are configurations in which lifting devices are omitted. In a device of this type, the wall element 21 is realized, for example, in the form of a flat disc with receptacle pockets for the container neck located on its edge. The containers are pushed into these receptacle pockets without any change in their local height by suitable pusher means. The open outer edges of the pockets are closed, for example, by a non-rotating element, as a result of which the consumption of sterile air can be kept low.

At the point where the caps or closures 13 in the cap or closure receiving position are transferred to the capping tools 14 that are moving past this position, the external wall element 19 is provided with an opening 26.

For the delivery of the inert gas, connections 27 are distributed around the axis VA in the upper portion of the wall element 19. The connections 27 each emerge in an upper sub-chamber 18.2 of the inner chamber 18. There is a perforated partition 28 between the two sub-chambers 18.1 and 18.2. In the illustrated embodiment this partition is also realized in the form of a circular ring and is oriented in a plane perpendicular to the axis VA. By means of the perforated partition 28 (perforated plate or laminator), a uniformly distributed or essentially uniformly laminar flow of the inert gas in the vertical direction from top to bottom is achieved in the sub-chamber 18.1, i.e. with a flow direction toward the bottle mouths 2.2, as indicated by the arrows C in FIGS. 2-4.

In the illustrated embodiment, on the wall element 19, in the direction of rotation B of the rotor 6, after the position in which the caps or closures 13 are transferred to the capping tools 14, there is at least one nozzle 29 past which the bottles 2 are moved with their bottle mouths 2.2. By means of the nozzle 29, each bottle 2 is sprayed with a jet 30 of inert gas in the interior of the bottle above the liquid level or in the space that is not occupied by the liquid being bottled (injection of inert gas), so that any residual air and oxygen in the respective bottle 2 can be removed.

The inert gas which is injected via the connections 27 and the nozzle 29 exits the inert gas chamber 18 or the sub-chamber 18.1 at openings which are formed in the lower area of the sub-chamber 18.1 not only by the gap 23 but in particular also by the respective annular gap between the edge of the openings 25 and the mouth areas of the bottles 2 and by the opening 26, so that the bottles 2 in their mouth area, the capping tools 14 and the caps 3 on the capping tools 14 are intensively flushed by the flow of inert gas, and the entry of oxygen into the bottles 2 which is harmful to the product or liquid is thereby effectively prevented with a low consumption of inert gas.

Especially as a result of the use of the nozzles 29 it is possible to prevent the entry of oxygen which has an adverse effect on the quality and/or shelf life of the product into the liquid, although the filling of the bottles 2 as well as the transport of the filled bottles 2 via the transport line 10 to the capping or closing machine 5 takes place under a normal atmosphere, for example, and only the capping of the bottles 2 is performed in the inert gas atmosphere, to ensure among other things the lowest possible consumption of inert gas. An additional factor in the reduction of the consumption of the inert gas is the fact that during the capping or closing the bottles 2 extend into the inert gas chamber 18 or into the sub-chamber 18.1 only with their mouth area, i.e. the inert gas area 18 has a reduced height in comparison to the height of the bottle and can therefore be realized with a relatively small volume.

Suitable gases for the inert gas atmosphere and/or for the inert gas injection are, for example, CO₂ or CO₂ gas and/or nitrogen.

The invention was described above on the basis of one exemplary embodiment. It goes without saying that numerous modifications and variations of the invention are possible without thereby going beyond the teaching of the invention.

For example, the invention is of course not limited to the use of closures 13 in the form of crown corks, but also includes the use of other types of closures and other capping or closing machines adapted to other types of closures.

### LIST OF REFERENCE NUMBERS

1 Plant
2 Bottle
2.1 Bottle bottom
2.2 Bottle mouth
3 Filling machine
4 Rotor of the filling machine 3
5 Capping machine
6 Rotor of the capping machine 5
7 Capping position
8 Conveyor for the supply of empty bottles 2
9 Bottle or container inlet
9.1 Inlet or transport star wheel
10 Transport line
10.1, 10.2, 10.3 Transport star wheel
11 Bottle or container outlet
11.1 Outlet or transport star wheel
12 Conveyor
13 Cap or closure
14 Capping tool
14.1 Stamp
14.2 Capping cone
15 Container or bottle carrier
16 Transfer position for caps or closures 13
17 Position
18 Inert gas chamber
18.1, 18.2 Sub-chamber
19-22 Wall element
23, 24 Gap
25, 26 Opening
27 Connection for the introduction of the inert gas
28 Perforated partition
29 Nozzle
30 Nozzle jet
A Direction of rotation of the rotor 4
B Direction of rotation of the rotor 6
C Laminar flow of the inert gas
D Exit of inert gas to the openings 25
E Exit of inert gas to the openings 26

1. Method for the closing or capping of bottles, cans or similar containers (2), in particular of containers (2) that are filled with an oxygen-sensitive liquid, with a capping or closing machine (5) under an inert gas atmosphere, characterized in that the closing or capping of the containers (2) takes place in an inert gas chamber (18) or sub-chamber (18.1) that contains the inert gas atmosphere formed by the closing or calling machine (5), in which the containers (2) are held during the closing or capping at least in the vicinity of their container mouth (2.2), wherein a rotor (6) that can be driven in rotation around a vertical machine axis (VA) with a plurality of closing or capping stations (7) that are realized on the perimeter of the rotor (6) and each of which has at least one closing or capping tool (14), whereby the inert gas chamber (18) or sub-chamber (18.1) is realized in the form of a chamber that surrounds the machine axis (VA), preferably in the form of an annular chamber that surrounds the machine axis (VA).

2. Method as recited in claim 1, characterized in that the closing or capping of the containers (2) takes place in a housing (19-22) of the closing or capping machine (5) that forms the inert gas chamber (18) or sub-chamber (18.1).

3. Method as recited in claim 1, characterized in that one of (A) and (B):
(A) during the closing capping, the containers (2) are contained in the inert gas chamber (18) or sub-chamber (18.1) only with a mouth area that has the respective container mouth (2.2) or with a portion of the height of the container which has the respective container mouth (2.2); and
(B) during the capping or closing the containers (2) are each enclosed completely, i.e. with their full container height, in the inert gas chamber (18) or sub-chamber (18.1).

4. (canceled)

5. Method as recited in claim 3, characterized in that the inert gas of the inert gas atmosphere is CO₂ or CO₂ gas and/or nitrogen.

6. Method as recited in claim 5, characterized in that the inert gas atmosphere has an oxygen content significantly less than 20%.

7. Method as recited in claim 6, characterized in that:
the inert gas atmosphere has an oxygen content <5%;
prior to the capping or closing of the containers (2), each container is gassed at least once with an inert gas via its container mouth (2.2);
the gassing of the containers (2) takes place in the inert gas chamber (18) or sub-chamber (18.1) that contains the inert gas atmosphere;
the gassing of the containers is performed by at least one inert gas jet that is emitted from a nozzle (29);
an inert gas flow, for example a laminar or essentially laminar inert gas flow, is generated in the inert gas chamber (18) or sub-chamber (18.1);
during the closing or capping, the containers (2) are flowed over by the inert gas at least in the area of their container mouth (2.2);
an inert gas current is generated in the inert gas chamber (18) or in the sub-chamber (18.1) directed toward the container mouths (2.2), for example with a flow direction from top to bottom or essentially from top to bottom;
the closures or caps (13) used for the closing or capping are flowed over by the inert gas during and/or before their installation on the containers (2); and
the containers (2) are filled in a normal atmosphere.

8. Method as recited in claim 1, characterized in that at least one of (A), (B), (C), (D), (E), (F), and (G):
(A) one of (i), (ii), (iii), (iv), and (v):
(i) the closing or capping of the containers (2) takes place in a housing (19-22) of the closing or capping machine (5) that forms the inert gas chamber (18) or sub-chamber (18.1);
(ii) during the closing or capping, the containers (2) are contained in the inert gas chamber (18) or sub-chamber (18.1) only with a mouth area that has the respective container mouth (2.2) or with a portion of the height of the container which has the respective container mouth (2.2); and
(iii) during the capping or closing the containers (2) are each enclosed completely, i.e. with their full container height, in the inert gas chamber (18) or sub-chamber (18.1);
(iv) the closing or capping of the containers (2) takes place in a housing (19-22) of the closing or capping machine (5) that forms the inert gas chamber (18) or sub-chamber (18.1); and
during the closing or capping, the containers (2) are contained in the inert gas chamber (18) or sub-chamber (18.1) only with a mouth area that has the respective container mouth (2.2) or with a portion of the height of the container which has the respective container mouth (2.2); and
(v) the closing or capping of the containers (2) takes place in a housing (19-22) of the closing or capping machine (5) that forms the inert gas chamber (18) or sub-chamber (18.1); and
during the capping or closing the containers (2) are each enclosed completely, i.e. with their full container height, in the inert gas chamber (18) or sub-chamber (18.1);
(B) the inert gas of the inert gas atmosphere is CO₂ or CO₂ gas and/or nitrogen;
(C) one of (vi) and (vii):
(vi) the inert gas atmosphere has an oxygen content significantly less than 20%; and
(vii) the inert gas atmosphere has an oxygen content significantly less than 20%; and
the inert gas atmosphere has an oxygen content <5%; (D) one of (viii), (ix), (x), (xi):
(viii) prior to the capping or closing of the containers (2), each container is gassed at least once with an inert gas via its container mouth (2.2);
(ix) prior to the capping or closing of the containers (2), each container is gassed at least once with an inert gas via its container mouth (2.2); and
the gassing of the containers (2) takes place in the inert gas chamber (18) or sub-chamber (18.1) that contains the inert gas atmosphere;
(x) prior to the capping or closing of the containers (2), each container is gassed at least once with an inert gas via its container mouth (2.2); and
the gassing of the containers is performed by at least one inert gas jet that is emitted from a nozzle (29); and
(xi) prior to the capping or closing of the containers (2), each container is gassed at least once with an inert gas via its container mouth (2.2);
the gassing of the containers (2) takes place in the inert gas chamber (18) or sub-chamber (18.1) that contains the inert gas atmosphere; and
the gassing of the containers is performed by at least one inert gas jet that is emitted from a nozzle (29); (E) one of (xii), (xiii), (xiv), and (xv):
(xii) an inert gas flow, for example a laminar or essentially laminar inert gas flow, is generated in the inert gas chamber (18) or sub-chamber (18.1);
(xiii) an inert gas flow, for example a laminar or essentially laminar inert gas flow, is generated in the inert gas chamber (18) or sub-chamber (18.1); and
during the closing or capping, the containers (2) are flowed over by the inert gas at least in the area of their container mouth (2.2);
(xiv) an inert gas flow, for example a laminar or essentially laminar inert gas flow, is generated in the inert gas chamber (18) or sub-chamber (18.1);
(xv) an inert gas flow, for example a laminar or essentially laminar inert gas flow, is generated in the inert gas chamber (18) or sub-chamber (18.1); and
an inert gas current is generated in the inert gas chamber (18) or in the sub-chamber (18.1) directed toward the container mouths (2.2), for example with a flow direction from top to bottom or essentially from top to bottom;
during the closing or capping, the containers (2) are flowed over by the inert gas at least in the area of their container mouth (2.2); and
an inert gas current is generated in the inert gas chamber (18) or in the sub-chamber (18.1) directed toward the container mouths (2.2), for example with a flow direction from top to bottom or essentially from top to bottom;
(F) the closures or caps (13) used for the closing or capping are flowed over by the inert gas during and/or before their installation on the containers (2); and
(G) the containers (2) are filled in a normal atmosphere.

9-15. (canceled)

16. Capping machine for the capping or closing of bottles, cans or similar containers (2) filled with a product or liquid, in particular with an oxygen-sensitive liquid, on their container mouths (2.2) with the use of caps or closures (13) under an inert gas atmosphere, with at least one capping or closing station (7) with a capping or closing tool (14), characterized by at least one inert gas chamber (18) or sub-chamber (18.1) that is realized on the capping or closing machine (5) and can be pressurized with the inert gas, in which the individual container (2) to be capped or closed is contained during the capping or closing at least with an area that has the container mouth (2.2), characterized by a rotor (6) that can be driven in rotation around a vertical machine axis (VA) with a plurality of closing or capping stations (7) that are realized on the perimeter of the rotor (6) and each of which has at least one closing or capping tool (14), whereby the inert gas chamber (18) or sub-chamber (18.1) is realized in the form of a chamber that surrounds the machine axis (VA), preferably in the form of an annular chamber that surrounds the machine axis (VA).

17. Capping or closing machine as recited in claim 16, characterized in that one of (A) and (B):
(A) the containers (2) are enclosed in the inert gas chamber (18) or sub-chamber (18.1) during the capping or closing only with a mouth area that has the respective container mouth (2.2) or with a portion of the container height that has the respective container mouth (2.2); and
(B) the containers (2) are enclosed during the capping or closing in their entirety, i.e. with their full container height, in the inert gas chamber (18) or sub-chamber (18.1).

18. (canceled)

19. Capping or closing machine as recited in claim 17, characterized in that:
the at least one capping or closing station (7) has a capping or closing tool (14) which is contained with its functional elements (14.1, 14.2) that interact with the respective cap or closure (13) and or container (2) in the inert gas chamber (18) at least during the capping or closing; and
the inert gas chamber (18) is separated from the ambient atmosphere by a housing (19-22).

20-21. (canceled)

22. Capping or closing machine for the capping or closing of bottles, cans or similar containers (2) filled with a product or liquid, in particular with an oxygen-sensitive liquid, on their container mouths (2.2) with the use of caps or closures (13) under an inert gas atmosphere, with at least one capping or closing station (7) with a capping or closing tool (14), characterized by at least one inert gas chamber (18) or sub-chamber (18.1) that is realized on the capping or closing machine (5) and can be pressurized with the inert gas, in which the individual container (2) to be capped or closed is contained during the capping or closing at least with an area that has the container mouth (2.2), characterized in that the housing (19-22) that forms the limits of the inert gas chamber (18) or sub-chamber (18.1) either rotates partly with the rotor (6) and is partly stationary, i.e. does not rotate with the rotor (6).

23. Capping or closing machine as recited in claim 20, characterized in that:
the at least one capping or closing station has at least one container carrier (15), and that the container carrier (15) is provided outside the inert gas chamber (18); and
characterized by connections (17) for the delivery of the inert gas into the inert gas chamber (18) and by outlets (23, 25, 26) for the discharge of the inert gas out of the inert gas chamber (18).

24. Capping or closing machine as recited in claim 22, characterized in that:
the at least one capping or closing station has at least one container carrier (15), and that the container carrier (15) is provided outside the inert gas chamber (18); and
characterized by connections (17) for the delivery of the inert gas into the inert gas chamber (18) and by outlets (23, 25, 26) for the discharge of the inert gas out of the inert gas chamber (18).

25. Capping or closing machine as recited in claim 23, characterized by:
means (28) for the production of an inert gas flow, preferably of a laminar or essentially laminar inert gas flow inside the inert gas chamber (18) or the sub-chamber (18.1); and
means (28) for the production of an inert gas flow which flows over and around the containers (2) at least in the area of their container mouth (2.2) during the capping or closing.

26. Capping or closing machine as recited in claim 24, characterized by
means (28) for the production of an inert gas flow, preferably of a laminar or essentially laminar inert gas flow inside the inert gas chamber (18) or the sub-chamber (18.1); and
means (28) for the production of an inert gas flow which flows over and around the containers (2) at least in the area of their container mouth (2.2) during the capping or closing.

27. Capping or closing machine as recited in claim 25:
characterized by means (28) for the production of an inert gas flow directed at the container mouths (2.2), for example with a flow direction from top to bottom or essentially from top to bottom;
characterized by means (29) for the gassing of the containers (2) with the inert gas in the portion of their interior not occupied by the liquid being bottled;
characterized in that the means for the gassing of the containers (2) are provided in the inert gas chamber (18);
characterized in that the means for the gassing of the containers (2) are formed by at least one nozzle for the discharge of at least one inert gas jet; and
characterized in that the inert gas is CO₂ and/or nitrogen; in a plant (1) for the filling and capping or closing of the containers (2), it is downstream of a filling machine (3) in which the filling of the containers (2) takes place preferably under a normal atmosphere.

28. Capping or closing machine as recited in claim 26, characterized by:
means (28) for the production of an inert gas flow directed at the container mouths (2.2), for example with a flow direction from top to bottom or essentially from top to bottom; and
means (29) for the gassing of the containers (2) with the inert gas in the portion of their interior not occupied by the liquid being bottled.

29. Capping or closing machine as recited in claim 27, characterized in that at least one of (C), (D), (E), (F), (G), (H), (I), (J), and (K):
(A) one of (i) and (ii):
(i) the containers (2) are enclosed in the inert gas chamber (18) or sub-chamber (18.1) during the capping or closing only with a mouth area that has the respective container mouth (2.2) or with a portion of the container height that has the respective container mouth (2.2); and
(ii) the containers (2) are enclosed during the capping or closing in their entirety, i.e. with their full container height, in the inert gas chamber (18) or sub-chamber (18.1);
(D) the at least one capping or closing station (7) has a capping or closing tool (14) which is contained with its functional elements (14.1, 14.2) that interact with the respective cap or closure (13) and or container (2) in the inert gas chamber (18) at least during the capping or closing;
(E) the inert gas chamber (18) is separated from the ambient atmosphere by a housing (19-22);
(F) the at least one capping or closing station has at least one container carrier (15), and that the container carrier (15) is provided outside the inert gas chamber (18);
(G) characterized by connections (17) for the delivery of the inert gas into the inert gas chamber (18) and by outlets (23, 25, 26) for the discharge of the inert gas out of the inert gas chamber (18);
(H) one of (iii), (iv), and (v):
(iii) characterized by means (28) for the production of an inert gas flow, preferably of a laminar or essentially laminar inert gas flow inside the inert gas chamber (18) or the sub-chamber (18.1);
(iv) characterized by means (28) for the production of an inert gas flow, preferably of a laminar or essentially laminar inert gas flow inside the inert gas chamber (18) or the sub-chamber (18.1); and
characterized by means (28) for the production of an inert gas flow which flows over and around the containers (2) at least in the area of their container mouth (2.2) during the capping or closing;
(v) characterized by means (28) for the production of an inert gas flow, preferably of a laminar or essentially laminar inert gas flow inside the inert gas chamber (18) or the sub-chamber (18.1); and
characterized by means (28) for the production of an inert gas flow directed at the container mouths (2.2), for example with a flow direction from top to bottom or essentially from top to bottom;
(vi) characterized by means (28) for the production of an inert gas flow, preferably of a laminar or essentially laminar inert gas flow inside the inert gas chamber (18) or the sub-chamber (18.1);
characterized by means (28) for the production of an inert gas flow directed at the container mouths (2.2), for example with a flow direction from top to bottom or essentially from top to bottom; and
characterized by means (28) for the production of an inert gas flow which flows over and around the containers (2) at least in the area of their container mouth (2.2) during the capping or closing;
(I) one of (vii), (viii), and (ix):
(vii) characterized by means (29) for the gassing of the containers (2) with the inert gas in the portion of their interior not occupied by the liquid being bottled;
(viii) characterized by means (29) for the gassing of the containers (2) with the inert gas in the portion of their interior not occupied by the liquid being bottled; and
the means for the gassing of the containers (2) are provided in the inert gas chamber (18);
(ix) characterized by means (29) for the gassing of the containers (2) with the inert gas in the portion of their interior not occupied by the liquid being bottled;
the means for the gassing of the containers (2) are formed by at least one nozzle for the discharge of at least one inert gas jet; and
(x) characterized by means (29) for the gassing of the containers (2) with the inert gas in the portion of their interior not occupied by the liquid being bottled;
the means for the gassing of the containers (2) are provided in the inert gas chamber (18); and
the means for the gassing of the containers (2) are formed by at least one nozzle for the discharge of at least one inert gas jet;
(J) the inert gas is CO₂ and/or nitrogen; and
(K) in a plant (1) for the filling and capping or closing of the containers (2), it is downstream of a filling machine (3) in which the filling of the containers (2) takes place preferably under a normal atmosphere.

30. Capping or closing machine as recited in claim 28, characterized in that:
the means for the gassing of the containers (2) are provided in the inert gas chamber (18);
the means for the gassing of the containers (2) are formed by at least one nozzle for the discharge of at least one inert gas jet;
the means for the gassing of the containers (2) are formed by at least one nozzle for the discharge of at least one inert gas jet; and
in a plant (1) for the filling and capping or closing of the containers (2), it is downstream of a filling machine (3) in which the filling of the containers (2) takes place preferably under a normal atmosphere.

31. Capping or closing machine as recited in claim 22, characterized in that at least one of (A), (B), (C), (D), (E), and (F):
(A) the at least one capping or closing station has at least one container carrier (15), and that the container carrier (15) is provided outside the inert gas chamber (18);
(B) characterized by connections (17) for the delivery of the inert gas into the inert gas chamber (18) and by outlets (23, 25, 26) for the discharge of the inert gas out of the inert gas chamber (18);
(c) one of (i), (ii), (iii), and (iv):
(i) characterized by means (28) for the production of an inert gas flow, preferably of a laminar or essentially laminar inert gas flow inside the inert gas chamber (18) or the sub-chamber (18.1);
(ii) characterized by means (28) for the production of an inert gas flow, preferably of a laminar or essentially laminar inert gas flow inside the inert gas chamber (18) or the sub-chamber (18.1); and
characterized by means (28) for the production of an inert gas flow which flows over and around the containers (2) at least in the area of their container mouth (2.2) during the capping or closing;
(iii) characterized by means (28) for the production of an inert gas flow, preferably of a laminar or essentially laminar inert gas flow inside the inert gas chamber (18) or the sub-chamber (18.1); and
characterized by means (28) for the production of an inert gas flow directed at the container mouths (2.2), for example with a flow direction from top to bottom or essentially from top to bottom; and
(iv) characterized by means (28) for the production of an inert gas flow, preferably of a laminar or essentially laminar inert gas flow inside the inert gas chamber (18) or the sub-chamber (18.1);
characterized by means (28) for the production of an inert gas flow which flows over and around the containers (2) at least in the area of their container mouth (2.2) during the capping or closing; and
characterized by means (28) for the production of an inert gas flow directed at the container mouths (2.2), for example with a flow direction from top to bottom or essentially from top to bottom;
(D) one of (v), (vi), (vii), and (viii):
(v) characterized by means (29) for the gassing of the containers (2) with the inert gas in the portion of their interior not occupied by the liquid being bottled;
(vi) characterized by means (29) for the gassing of the containers (2) with the inert gas in the portion of their interior not occupied by the liquid being bottled; and
the means for the gassing of the containers (2) are provided in the inert gas chamber (18);
(vii) characterized by means (29) for the gassing of the containers (2) with the inert gas in the portion of their interior not occupied by the liquid being bottled; and
the means for the gassing of the containers (2) are formed by at least one nozzle for the discharge of at least one inert gas jet; and
(viii) characterized by means (29) for the gassing of the containers (2) with the inert gas in the portion of their interior not occupied by the liquid being bottled;
the means for the gassing of the containers (2) are provided in the inert gas chamber (18); and
the means for the gassing of the containers (2) are formed by at least one nozzle for the discharge of at least one inert gas jet;
(E) the inert gas is CO₂ and/or nitrogen; and
(F) in a plant (1) for the filling and capping or closing of the containers (2), it is downstream of a filling machine (3) in which the filling of the containers (2) takes place preferably under a normal atmosphere.

32. (canceled)
